(19) United States
(12) Patent Application Publication
(10) Pub. No.: US 2016/0024294 A1
(43) Pub. Date: Jan. 28, 2016

(54) HEAT-CURABLE EPOXY RESIN COMPOSITION FOR ENCAPSULATING OPTICAL SEMICONDUCTOR ELEMENT AND OPTICAL SEMICONDUCTOR DEVICE USING SAME

(71) Applicant: SHIN-ETSU CHEMICAL CO., LTD., Tokyo (JP)

(72) Inventors: Yoshihiro TSUTSUMI, Annaka-shi (JP); Tadashi TOMITA, Annaka-shi (JP)

(73) Assignee: SHIN-ETSU CHEMICAL CO., LTD., Tokyo (JP)

(21) Appl. No.: 14/804,473

(22) Filed: Jul. 21, 2015

(30) Foreign Application Priority Data
Jul. 22, 2014 (JP) 2014-148869
Jul. 22, 2014 (JP) 2014-148871

(51) Int. Cl. C08L 63/00

(52) U.S. Cl. CPC C08L 63/00; C08L 2205/025

(57) ABSTRACT

Provided is a heat-curable epoxy resin composition for encapsulating an optical semiconductor element. The resin composition exhibits a high strength and elastic modulus even in a high-temperature environment, hardly turns yellow due to an uneven hardening that occurs immediately after molding, and is solid under a room temperature such that the resin composition can be handled easily. The resin composition includes: a prepolymer obtained through a reaction of (A) a triazine derivative epoxy resin, (B) at least one epoxy resin selected from a group of (B-1) a bisphenol A-type epoxy resin, (B-2) a bisphenol F-type epoxy resin, (B-3) a hydrogenated bisphenol A-type epoxy resin and (B-4) an alicyclic epoxy resin and (C) an acid anhydride curing agent, at an epoxy group equivalent/acid anhydride group equivalent ratio of 0.6 to 2.0; and (D) a curing accelerator, such resin composition capable of being pressure molded under a room temperature before thermally cured.

### BACKGROUND OF THE INVENTION

1. Field of the Invention

The present invention relates to a heat-curable epoxy resin composition for encapsulating an optical semiconductor element. Particularly, the heat-curable epoxy resin composition of the present invention exhibits a favorable mold releasability without impairing the transparency of a cured product, a high strength and elastic modulus even in a high-temperature environment; hardly turns yellow due to an uneven hardening that occurs immediately after molding; and is solid under a room temperature such that the resin composition can be handled easily. Further, the present invention also relates to an optical semiconductor device obtained by encapsulating an optical semiconductor element with such heat-curable epoxy resin composition.

2. Background Art

Optical semiconductor elements such as LEDs (Light Emitting Diode) have been used in various indicators and light sources such as those for street displays, automobile lamps and residential lightings. Moreover, since such optical semiconductor elements are now key items for carbon dioxide reduction and energy conservation, products using the same are being rapidly developed in many fields.

### DESCRIPTION OF RELATED ART

As an encapsulation material for encapsulating various optical semiconductor elements such as LEDs, there has been generally used a heat-curable epoxy resin made of: an epoxy resin such as a bisphenol A-type epoxy resin or an alicyclic epoxy resin; and an acid anhydride-based curing agent, for the purpose of ensuring a superior transparency, moisture resistance, heat resistance and light resistance of a cured product thereof (Japanese Unexamined Patent Application Publication No. Hei 7-309927).

However, when a multifunctional epoxy resin and/or an alicyclic epoxy resin is simply melted for use to improve the heat resistance and light resistance, a decrease in the strength of such encapsulation resin may occur easily. That is, when using such epoxy resin composition to encapsulate and mold an optical semiconductor element, there exists a problem that the resin may crack easily and a molded product may turn yellow easily as well due to an uneven hardening.

Further, since surface-mount packaging may require an exposure to a high-temperature environment of 260° C. when, for example, performing a reflow, developments have been made to restrict the crack occurrence by decreasing an elastic modulus at a high temperature and thus improving a crack resistance when performing solder reflow (Japanese Patent No. 5101425). Meanwhile, lamps for automobiles or the like may, for example, be manufactured by using an epoxy resin to encapsulate an optical semiconductor element on a lead frame in a lenticular manner, and then using a thermoplastic resin to perform secondary molding (e.g. injection molding) thereon. Here, the thermoplastic resin is heated to approximately 300° C., and molded under a high pressure. Therefore, even if a heat-curable resin (epoxy resin) has a high glass-transition temperature, the heat-curable resin exhibiting a low strength and elasticity at a high temperature may push a lens portion aside such that the optical semiconductor element may not be able to emit light.

Moreover, there also exists a problem where an epoxy resin for encapsulating an optical semiconductor may solidly adhere to a mold, if used for molding as is the case with the aforementioned epoxy resin composition. In short, the problem has been that it is extremely difficult to remove a molded package from a mold, since a cured product of the resin composition may solidly adhere to the mold, such cured product being obtained after performing molding using the epoxy resin for encapsulating an optical semiconductor.

In order to solve the aforementioned problems, reports have been made on attempts to use a polyether type mold release agent having ester, carboxylic acid or metal ester on terminal ends thereof (Japanese Unexamined Patent Application Publication No. Hei 9-208805). However, a problem with such mold release agent is that while there can be achieved a superior transparency of the cured product, an insufficient continuous moldability is exhibited.

### SUMMARY OF THE INVENTION

Therefore, it is an object of the present invention to provide a heat-curable epoxy resin composition for encapsulating an optical semiconductor element, which exhibits a high strength and elastic modulus even in a high-temperature environment, hardly turns yellow due to an uneven hardening that occurs immediately after molding, and is solid under a room temperature such that the resin composition can be handled easily; a heat-curable epoxy resin composition for encapsulating an optical semiconductor element, which exhibits a favorable mold releasability without impairing the transparency of a cured product; and an optical semiconductor device obtained by encapsulating an optical semiconductor element with such heat-curable epoxy resin compositions.

In order to overcome the aforementioned problems, the inventors of the present invention made the invention as follows through diligent studies.

That is, the inventors invented a heat-curable epoxy resin composition containing: a prepolymer obtained through a reaction of a particular epoxy resin(s) and an acid anhydride curing agent; and a curing accelerator. The inventors found that this heat-curable epoxy resin composition exhibited a high strength and elastic modulus even in a high-temperature environment, hardly turned yellow due to an uneven hardening occurring immediately after molding, and was solid under a room temperature such that the resin composition of the present invention could be handled easily. Further, the inventors found that by adding a particular mold release agent to such heat-curable epoxy resin composition containing a particular epoxy resin(s), an acid anhydride curing agent and a curing accelerator, there could be obtained a heat-curable epoxy resin composition for encapsulating an optical semiconductor element, which exhibited a favorable mold releasability without impairing the transparency of a cured product.

Specifically, the present invention provides the following compositions and an optical semiconductor device using the same.

### 1

### First Embodiment

A heat-curable epoxy resin composition for encapsulating an optical semiconductor element, including:

a prepolymer obtained through a reaction of
(A) a triazine derivative epoxy resin,
(B) at least one epoxy resin selected from the group consisting of (B-1) a bisphenol A-type epoxy resin, (B-2) a bisphenol F-type epoxy resin, (B-3) a hydrogenated bisphenol A-type epoxy resin and (B-4) an alicyclic epoxy resin and
(C) an acid anhydride curing agent, in an epoxy group equivalent to acid anhydride group equivalent ratio of 0.6 to 2.0; and
(D) a curing accelerator, in which the heat-curable epoxy resin composition is capable of being pressure molded under a room temperature before being thermally cured.

### 2

### Second Embodiment

A heat-curable epoxy resin composition for encapsulating an optical semiconductor element, including:
(A) a triazine derivative epoxy resin;
(B) at least one epoxy resin selected from the group consisting of (B-1) a bisphenol A-type epoxy resin, (B-2) a bisphenol F-type epoxy resin, (B-3) a hydrogenated bisphenol A-type epoxy resin and (B-4) an alicyclic epoxy resin;
(C) an acid anhydride curing agent;
(D) an curing accelerator; and
(E) a mold release agent, such mold release agent being a mixture of glycerin fatty acid ester, propylene glycol fatty acid ester and higher alcohol fatty acid ester.

### 3

The heat-curable epoxy resin composition according to <1> for encapsulating an optical semiconductor element, exhibiting a glass-transition temperature of not lower than 130° C. when measured through thermo-mechanical analysis (TMA).

An optical semiconductor device obtained by encapsulating an optical semiconductor element through transfer molding, using the heat-curable epoxy resin composition as set forth in any one of <1> to <3>.

According to the present invention, there can be provided a heat-curable epoxy resin composition for encapsulating an optical semiconductor element, which exhibits a high strength and elastic modulus even in a high-temperature environment, hardly turns yellow due to an uneven hardening that occurs immediately after molding, and is solid under a room temperature such that the resin composition can be handled easily; a heat-curable epoxy resin composition for encapsulating an optical semiconductor element, which exhibits a favorable mold releasability without impairing the transparency of a cured product; and an optical semiconductor device obtained by encapsulating an optical semiconductor element such as a light receiving element with cured products of such compositions.

### DETAILED DESCRIPTION OF THE INVENTION

The present invention is described in greater detail hereunder.

Described hereunder are the components of the composition of the present invention.

### <(A) Triazine Derivative Epoxy Resin>

A triazine derivative epoxy resin as a component (A) of the present invention is used in a manner such that it is melted and mixed with a component (B) and a component (C). By using such triazine derivative epoxy resin as the component (A), improved is a transparency of a cured product of a heat-curable epoxy resin composition, and there can be obtained a semiconductor luminescent device hardly exhibiting deterioration with time. Further, the triazine derivative epoxy resin as the component (A), when coupled with the components (B) and (C), is capable of improving a strength of the cured product of the heat-curable epoxy resin composition in a high temperature environment; restricting yellowing; and again allowing there to be obtained a semiconductor luminescent device hardly exhibiting deterioration with time. As such triazine derivative epoxy resin, 1,3,5-triazine nucleus derivative epoxy resin is preferred. Particularly, an epoxy resin having an isocyanurate ring(s) exhibits a superior light resistance and electrical insulation property, and it is desired that a divalent, more preferably a trivalent epoxy group be present in each isocyanurate ring. Specific examples include tris(2,3-epoxypropyl) isocyanurate, and tris(α-methylglycidyl) isocyanurate.

It is preferred that the triazine derivative epoxy resin used in the present invention have a softening point of 40 to 125° C. However, in the present invention, such triazine derivative epoxy resin does not include a triazine derivative epoxy resin whose triazine ring has been hydrogenated.

<(B) Specific Epoxy Resin Other than (A)>

In the present invention, other than the triazine derivative epoxy resin as the component (A), there is also used an epoxy resin as the component (B) which is at least one epoxy resin selected from the group consisting of (B-1) a bisphenol A-type epoxy resin; (B-2) a bisphenol F-type epoxy resin; (B-3) a hydrogenated bisphenol A-type epoxy resin; and (B-4) an alicyclic epoxy resin. By adding the component (B), a toughness of the cured product of the heat-curable epoxy resin composition can be improved, and there can be obtained a semiconductor luminescent device hardly exhibiting deterioration with time. It is preferred that the component (B) be that in a solid form under a room temperature in terms of ease of handling the same and performing prepolymerization, and that the epoxy resin as the component (B) have a softening point of 50 to 100° C.

### <(C) Acid Anhydride>

It is preferred that an acid anhydride as the component (C) used in the present invention serve as a curing agent, be a non-aromatic compound for the purpose of giving light resistance and have no carbon-carbon double bond. Examples of such acid anhydride include hexahydrophthalic anhydride, methylhexahydrophthalic anhydride, trialkyltetrahydrophthalic anhydride and hydrogenated methylnadic anhydride, among which hexahydrophthalic anhydride and/or methylhexahydrophthalic anhydride are preferred. In fact, not only one kind, but two or more kinds of these acid anhydride-based curing agents may be used in combination.

A ratio of (molar number of all the epoxy groups in the components (A) and (B))/(molar number of (C) acid anhydride) is preferably 0.6 to 2.0, more preferably 0.8 to 1.8, particularly preferably 1.0 to 1.6. When such ratio is less than 0.6, unreacted curing agent may remain in the cured product such that a moisture resistance of the cured product obtained may be degraded, and solidification under a room temperature may thus be difficult even after performing prepolymerization. Meanwhile, a ratio greater than 2.0 may lead to insufficient curing and a decrease in the reliability.

As for a ratio between the component (A) and component (B), it is preferred that a mass ratio be within a range of (A):(B)=40:60 to 90:10. If the component (A) is used in an amount greater than this range, the cured product will exhibit a high hygroscopic property such that the cured product becomes fragile more easily. In contrast, when the component (A) is used in an amount smaller than this range, a heat resistance and the light resistance of the cured product will decrease easily. Further, if a component (A) is used in an amount greater than this range, a handling property after performing prepolymerization will decrease easily. In contrast, if the component (A) is used in an amount smaller than this range, the strength and an elastic modulus of the cured product being heated will decrease easily. Particularly, as for a ratio between the component (A) and component (B), it is preferred that a mass ratio be within a range of (A):(B)=50:50 to 80:20.

As the reaction conditions for performing prepolymerization on the components (A), (B) and (C), the components (A), (B) and (C) may, for example, be subjected to such reaction at 60 to 120° C., preferably 70 to 110° C. for 3 to 20 hours, preferably 4 to 15 hours. At that time, prepolymerization may be performed in advance on the component (C); and any one of the components (A) and (B), and the rest of the component(s) may be added later. In this way, there can be obtained a prepolymer as a solid product having a softening point of 50 to 100° C., preferably 60 to 80° C. When the softening point of the substance obtained through such reaction is lower than 40° C., it will be difficult for the product to become a solid, thus also making it difficult to perform pressure molding under the room temperature. However, a softening point greater than 100° C. may lead to an excessively low flowability of the composition as required to perform molding.

### <(D) Curing Accelerator>

A curing accelerator as a component (D) is added to cure the heat-curable epoxy resin. Here, no particular limitation is imposed on such curing accelerator. In fact, there can be used a known curing accelerator for a heat-curable epoxy resin composition. For example, there may be used at least one of tertiary amines, imidazoles, organic carboxylates of such tertiary amines and imidazoles; organic carboxylate metal salts; metal-organic chelate compounds; aromatic sulfonium salts; and phosphorous curing catalysts such as organic phosphine compounds and phosphonium compounds and salts thereof. Among the aforementioned substances, preferred are imidazoles and phosphorous curing catalysts such as 2-ethyl-4-methylimidazole, 1-benzyl-2-phenylimidazole, methyltributylphosphonium-dimethylphosphate and octylic acid salt of tertiary amine.

It is preferred that the curing accelerator be added in an amount of 0.05 to 5% by mass, particularly preferably 0.1 to 2% by mass with respect to the total amount of components (A), (B) and (C). When the amount of the curing accelerator added is out of such range, a balance between the heat resistance and moisture resistance of the cured product of the heat-curable epoxy resin composition may worsen such that curing at the time of performing molding may take place either extremely fast or extremely slow.

### <(E) Mold Release Agent>

A particular mold release agent is added to a heat-curable epoxy resin composition of a second embodiment of the present invention. The mold release agent as a component (E) is added to improve a mold releasability at the time of performing molding.

As such mold release agents, there have been used, for example, natural waxes such as carnauba wax; and synthesized waxes such as acid wax, polyethylene wax and fatty acid ester. However, since these mold release agents are not perfectly compatible with the heat-curable epoxy resin, they will exude on the surface such that the transparency of the cured product of the heat-curable epoxy resin will be impaired. Moreover, many of these mold release agents will lose their mold releasabilities through easy yellowing and time degradation when exposed to a high temperature and light irradiation environment. In contrast, while a mold release agent with a high compatibility will help improve the transparency of the cured product, there has been a problem where such mold release agent will exhibit a poor mold releasability.

It was confirmed in the present invention that there could be obtained a cured product exhibiting a favorable balance between compatibility and mold releasability, having a high mold releasability and transparency and hardly discoloring, by using glycerin fatty acid ester, propylene glycol fatty acid ester and higher alcohol fatty acid ester, as the particular mold release agent.

Examples of glycerin fatty acid ester include glycerin monostearate, glycerin monobehenate, glycerin monooleate, glycerin monolaurate, stearyl stearate, glycerin dibehenate and glycerin dioleate.

Examples of propylene glycol fatty acid ester include propylene glycol monolaurate, propylene glycol monopalmitate, propylene glycol monostearate, propylene glycol monooleate and propylene glycol monobehenate.

Examples of higher alcohol fatty acid ester include stearyl stearate, lauryl stearate, lauryl laurate and stearyl behenate.

As for composition ratios among glycerin fatty acid ester, propylene glycol fatty acid ester and higher alcohol fatty acid ester that are added, it is preferred that the ratio of propylene glycol fatty acid ester be 1.0 to 10.0 by mass, particularly preferably 3.0 to 7.0 by mass, and that the ratio of higher alcohol fatty acid ester be 1.0 to 5.0 by mass, particularly preferably 1.0 to 3.0 by mass, provided that the ratio of glycerin fatty acid ester by mass is 1.0. Composition ratios out of such ranges may cause the transparency of the cured product to be impaired and make it impossible to achieve a favorable mold releasability.

It is preferred that the mold release agent as the component (E) be added in an amount of 0.50 to 10.0% by mass, particularly preferably 1.0 to 7.0% by mass with respect to the total amount of the components (A), (B) and (C). When the amount of the component (E) added is smaller than 0.50% by mass, there may not be achieved a sufficient mold releasability. Meanwhile, when the amount of the component (E) added is greater than 10.0% by mass, failures such as a bleeding failure and an adhesion failure may occur.

The following components, for example, may also be added to the composition of the present invention in addition to the aforementioned components if necessary, as long as the effects of the heat-curable epoxy resin composition are not impaired.

### (F) Antioxidant

An (F) antioxidant may be added to the heat-curable epoxy resin composition of the present invention to improve an initial reflectivity and maintain a reflectivity for a long period of time. The antioxidant as the component (F) may be a phenol-based, phosphorus-based or sulfur-based antioxidant. Specific examples of such antioxidant are as follows.

Examples of phenol-based antioxidant include 2,6-di-t-butyl-p-cresol; butylated hydroxyanisole; 2,6-di-t-butyl-p-ethylphenol; stearyl-β-(3,5-di-t-butyl-4-hydroxyphenyl)propionate; 2,2′-methylenebis(4-methyl-6-t-butylphenol); 4,4′-butylidenebis(3-methyl-6-t-butylphenol); 3,9-bis[1,1-dimethyl-2-{β-(3-t-butyl-4-hydroxy-5-methylphenyl) propionyloxy}ethyl]2,4,8,10-tetraoxaspiro[5,5]undecane; 1,1,3-tris(2-methyl-4-hydroxy-5-t-butylphenyl) butane; and 1,3,5-trimethyl-2,4,6-tris(3,5-di-t-butyl-4-hydroxybenzyl)benzene.

Examples of phosphorous-based antioxidant include triphenyl phosphite, diphenylalkyl phosphite, phenyldialkyl phosphite, tri(nonylphenyl)phosphite, trilauryl phosphite, trioctadecyl phosphite, distearyl pentaerythritol diphosphate, tris(2,4-di-tert-butylphenyl)phosphite, diisodecyl pentaerythritol diphosphate, di(2,4-di-tert-butylphenyl)pentaerythritol diphosphate, tristearyl sorbitol triphosphite and tetrakis(2,4-di-tert-butylphenyl)-4,4′-biphenyl diphosphonate.

Examples of sulfur-based antioxidant include dilauryl thiopropionate, distearyl thiopropionate, dibenzyl disulfide and trisnonylphenyl phosphite.

In fact, not only one kind, but two or more kinds of these antioxidants may be used in combination. It is preferred that the antioxidant be added in an amount of 0.01 to 10% by mass, particularly preferably 0.03 to 8% by mass with respect to the total amount of the components (A), (B) and (C). If the amount of the antioxidant added is below such lower limit, there cannot be achieved a sufficient heat resistance such that the cured product may discolor. If the amount of the antioxidant added is beyond such upper limit, curing inhibition will occur such that there may not be achieved a sufficient curability and strength, and the cured product may discolor due to the deterioration of the antioxidant itself.

### (G) Coupling Agent

A coupling agent such as a silane coupling agent and a titanate coupling agent may be added to the heat-curable epoxy resin composition of the present invention for the purpose of improving an adhesion strength to a metal base material such as a lead frame. Preferable examples of such coupling agent include an epoxy functional alkoxysilane such as γ-glycidoxypropyltrimethoxysilane, γ-glycidoxypropylmethyldiethoxysilane and β-(3,4-epoxycyclohexyl)ethyltrimethoxysilane; and a mercapto functional alkoxysilane such as γ-mercaptopropyltrimethoxysilane. However, it is not preferable to use a type of coupling agent (e.g. amine-based coupling agent) causing the heat-curable resin to discolor when left at a temperature of not lower than 150° C. Here, no particular limitation is imposed on a surface treatment method of the coupling agent. In fact, such surface treatment method can be properly determined in accordance with a common practice.

It is preferred that the component (G) be added in an amount of 0.05 to 2.0% by mass, particularly preferably 0.1 to 1.5% by mass with respect to the total amount of the components (A), (B) and (C). When the amount of the component (G) added is smaller than 0.05% by mass, an adhesion effect to the base material may be insufficient. When the amount of the component (G) added is greater than 2.0% by mass, a viscosity may decrease to an extremely low level such that voids may be formed.

### (H) Reinforcement Material

A reinforcement material as a component (H) can be added to the heat-curable epoxy resin composition of the present invention for the purpose of improving the strength under a room temperature and in a high-temperature environment; and for the purpose of restricting cracks at the time of performing molding.

As such reinforcement material, there can be used those normally added to an epoxy resin composition. Examples of such reinforcement material include silicas such as molten silica and crystalline silica, alumina, silicon nitride, aluminum nitride and glass fibers, among which glass fibers are preferred due to the fact that their reflective indexes are only slightly different from that of the cured product. Particularly, glass fibers with low-impurity concentrations are preferred.

It is preferred that such glass fibers have an average diameter of 5.0 to 25.0 μm, particularly preferably 8.0 to 15.0 μm. An excessively small average diameter may result in a small reinforcement effect on the cured product, and cause a mechanical strength thereof to be improved in an insufficient manner. Meanwhile, an excessively large average diameter may result in a non-uniform appearance of the cured product.

It is preferred that an average length of such glass fibers be 50 to 400 μm, more preferably 60 to 300 μm. An excessively short average length may result in a small reinforcement effect on the cured product, and cause the mechanical strength of the cured product to be improved in an insufficient manner. In contrast, an excessively long average length may result in clogging at a gate and a runner sections of a mold when performing molding, and a non-uniform appearance of the cured product.

It is preferred that the component (H) be added in an amount of 0.5 to 10% by mass with respect to the amount of the component (A). When the component (H) is added in an excessively large amount, the transparency of the cured product may decrease to an extremely low level such that there may not be achieved an expected light-extraction efficiency.

### Other Additive Agent

Various additive agents may further be added, if necessary, to the heat-curable epoxy resin composition of the present invention, as long as the transparency of the cured product does not decrease thereby. For example, there can be added various additive agents such as a silicone powder, a thermoplastic resin, a thermoplastic elastomer and an organic synthetic rubber for the purpose of improving the properties of the resin, provided that the effects of the present invention shall not be impaired in this way.

The heat-curable epoxy resin composition of the present invention can, for example, be produced in the following manner. That is, there are combined, at a given ratio, the components (A) to (E); and the components (F) to (H) and other additives if necessary. These are melted and mixed, and then cooled. The product thus obtained can be used as it is if it is to be used in the form of a liquid or a paste. However, if it is to be used in the form of a solid, either a maturing process is required; or prepolymerization has to be performed on at least the components (A) to (C), followed by crushing the same into an appropriate size and then tableting the same if necessary to obtain a molding material of the heat-curable epoxy resin composition. When performing such prepolymerization, the components can actually be thrown in in no particular order. For example, the component (F) or the like may have already been thrown in beforehand when performing prepolymerization on the components (A), (B) and (C).

Further, in a first embodiment of the present invention, the component (A) may, for example, be added at a given composition ratio, followed by performing prepolymerization on the same through thermal mixing by a gate mixer or the like, and then adding, at a given ratio, the component (B); and the components (C) to (F) and the like if necessary. These are melted and mixed, and then cooled and solidified, and are later crushed into an appropriate size after being cooled and solidified. Here, the components can be thrown in in no particular order. For example, the component (C) or the like may have been thrown in beforehand when performing prepolymerization on the component (A). Moreover, it may also be that prepolymerization be performed only on the component (A) which is cooled and solidified later and is further crushed into an appropriate size. Subsequently, the curing accelerator as the component (D); and other additives if necessary are added thereto at a given composition ratio, and a mixer or the like is then used to mix the same to a thoroughly uniform level. Next, a melting and mixing treatment is performed using a heated roll, a kneader, an extruder or the like, followed by cooling and solidifying the same and then crushing the same into an appropriate size to obtain a molding material of the heat-curable epoxy resin composition.

A known molding method such as a transfer molding method can be employed to encapsulate an optical semiconductor element using the heat-curable epoxy resin composition of the present invention. If employing a transfer molding method, it is preferred that a transfer molding machine be used, and that the method be performed under a molding pressure of 5 to 20 N/mm² and at a molding temperature of 120 to 190° C. for a molding period of 30 to 500 seconds, particularly preferably at a molding temperature of 150 to 185° C. for a molding period of 90 to 300 seconds. In addition, post curing may be performed at 150 to 185° C. for 0.5 to 20 hours.

It is preferred that the cured product of the heat-curable epoxy resin composition of the present invention exhibit a light transmittance of not lower than 70%, particularly preferably not lower than 80% at 600 nm when measured with a spectrophotometer, and provided that the cured product has a thickness of 1 mm. A cured product exhibiting such light transmittance can be obtained by improving the dispersibility of each component, and then melting and mixing the same until the components compatible with one another are uniformly mixed together. Here, a cured product exhibiting the light transmittance of not lower than 70% at 600 nm can be obtained by improving the dispersibility of each component, particularly by making the (A) triazine derivative epoxy resin compatible with other components. If performing prepolymerization, melting and mixing can resolve an unevenness and improve the dispersibility.

### Working Example

The present invention is described in detail hereunder with reference to working and comparative examples. However, the present invention is not limited to the following working examples.

The raw materials used in the working and comparative examples are as follows.

### <(A) Triazine Derivative Epoxy Resin>

(A-1) tris(2,3-epoxypropyl) isocyanurate (product name: TEPIC-S by Nissan chemical industries, ltd., epoxy equivalent of 100)

<(B) Epoxy Resin Other than Component (A)>

(B-1) solid bisphenol A-type epoxy resin (product name: jER-1001 by Mitsubishi Chemical Corporation, epoxy equivalent of 475)

(B-2) solid alicyclic epoxy resin (product name: EHPE-3150 by Daicel Corporation, epoxy equivalent of 170)

(B-3) liquid alicyclic epoxy resin (product name: Celloxide 2021P by Daicel Corporation, epoxy equivalent of 135)

(B-4) solid bisphenol F-type epoxy resin (product name: jER-4004P by Mitsubishi Chemical Corporation, epoxy equivalent of 900)

### <(C) Acid Anhydride>

(C-1) methylhexahydrophthalic anhydride (product name: RIKACID MH by New Japan Chemical Co., Ltd., acid anhydride equivalent of 168)

### <(D) Curing Accelerator>

(D-1) imidazole-based curing catalyst; 2-ethyl-4-methyl imidazole (product name: 2E4MZ by Shikoku Chemicals Corporation)

(D-2) phosphorus-based curing catalyst; tetra-n-butylphosphonium-O, O-diethyl phosphorodithiolate (product name: HISHICOLIN PX-4ET by Nippon Chemical Industrial Co., Ltd)

### <(E) Mold Release Agent>

(E-1) glycerin monostearate (product name: POEM V-100 by Riken Vitamin Co., Ltd.)

(E-2) propylene glycol monopalmitate (product name: RIKEMAL PP-100 by Riken Vitamin Co., Ltd.)

(E-3) stearyl stearate (product name: RIKEMAL SL-800 by Riken Vitamin Co., Ltd.)

(E-4) carnauba wax (product name: TO WAX-131 by Toa Kasei Co., Ltd.)

(E-5) oxidized polyethylene wax (product name: H-22 by Clariant (Japan) K.K.)

(E-6) ester wax (product name: LICOWAX E by Clariant (Japan) K.K.)

### Working Examples 1 to 6

### Comparative Examples 1 to 4

The components (A), (B) and (C) were added at the ratios shown in the following Table 1, followed by performing prepolymerization by melting and mixing the same for 6 hours in a gate mixer that had been heated to 85° C. Subsequently, the component (D) was further added thereto to perform melting and mixing for another 5 min, followed by cooling, solidifying and then crushing a product thus prepared to obtain the target epoxy resin composition in a powdery state.

### Comparative Examples 5 to 7

The components (A) to (D) were added at the ratios shown in the following Table 1, followed by melting and mixing the same for 10 min in a gate mixer that had been heated to 85° C. A product thus prepared was then cooled to obtain an epoxy resin composition in a state of solid or paste.

Various properties of such composition were measured as follows. The results thereof are shown in Table 1.

### Handling Property of Composition

A workability at the time of performing melting and mixing using the gate mixer was evaluated in accordance with the following standard(s).

∘: Obtained composition easily tabletable after cooling
x: Only obtained composition not easily tabletable after cooling

### Yellowing of Molded Product

Molded samples obtained by performing transfer molding on the heat-curable epoxy resin were evaluated in accordance with the following standard(s).

∘: colorless and transparent molded sample
x: transparent but yellowing molded sample

### Bending Strength and Bending Elastic Modulus Under Room or High Temperature

A mold made in accordance with the standard of JIS-K6911: 2006 was used to perform molding at a molding temperature of 175° C. and under a molding pressure of 6.9 N/mm² for a molding period of 120 seconds, followed by performing post curing at 180° C. for an hour. The bending strengths and elastic moduli of the post-cured test samples were measured at a room temperature (25° C.) or a high temperature (260° C.).

### Glass-Transition Temperature (Tg)

A mold made in accordance with the EMMI standard was used to perform molding at the molding temperature of 175° C. and under the molding pressure of 6.9 N/mm² for the molding period of 120 seconds, followed by performing post curing at 180° C. for an hour. The post-cured test samples were evaluated using TMA (TMA 8310 by Rigaku Corporation).

### Light Transmittance

A sheet-like cured product having a thickness of 1 mm was produced at the molding temperature of 175° C. and under the molding pressure of 6.9 N/mm² for the molding period of 120 seconds. The light transmittance of such cured product at 600 nm was measured with spectrophotometer U-4100 (by Hitachi High-Technologies Corporation).

TABLE 1

| | | | | Working example | | | | | | Comparative example | |
|---|---|---|---|---|---|---|---|---|---|---|---|
| Composition recipe (parts by mass) | | | | 1 | 2 | 3 | 4 | 5 | 6 | 1 | 2 |
| (A) | Epoxy resin | TEPIC-s | A-1 | 35.0 | 25.0 | 35.0 | 35.0 | 22.3 | 42.3 | 41.2 | 19.6 |
| (B) | Epoxy resin | jER-1001 | B-1 | 15.0 | 25.0 | | | 9.6 | 18.3 | | 8.4 |
| | | EHPE-3150 | B-2 | | | | 20.0 | | | | |
| | | JER-4004P | B-4 | | | 15.0 | | | | | |
| (C) | Acid | RIKACID MH | C-1 | 50.0 | 50.0 | 50.0 | 50.0 | 68.1 | 39.4 | 58.3 | 72.0 |
| | anhydride | | | | | | | | | | |
| (D) | Curing | HISHICOLIN | D-2 | 0.3 | 0.3 | 0.3 | 0.3 | 0.3 | 0.3 | 0.3 | 0.3 |
| | accelerator | PX-4ET | | | | | | | | | |
| Condi- | Prepolymerization | | | Per- | Per- | Per- | Per- | Per- | Per- | Per- | Per- |
| tion | | | | formed | formed | formed | formed | formed | formed | formed | formed |
| | (Molar number of all | | | 1.3 | 1.0 | 1.2 | 1.5 | 0.6 | 2.0 | 1.2 | 0.5 |
| | epoxy groups)/(Molar | | | | | | | | | | |
| | number of acid anhydride) | | | | | | | | | | |
| Evaluation | Handling property of | | | ∘ | ∘ | ∘ | ∘ | ∘ | ∘ | x | x |
| results | composition | | | | | | | | | | |
| | Yellowing of molded | | | ∘ | ∘ | ∘ | ∘ | ∘ | ∘ | ∘ | ∘ |
| | product | | | | | | | | | | |
| | Room | Bending strength | MPa | 80 | 92 | 71 | 75 | 74 | 75 | 75 | 42 |
| | temperature | Bending elastic | MPa | 2600 | 2500 | 2400 | 2700 | 2300 | 2700 | 2600 | 2700 |
| | (25° C.) | modulus | | | | | | | | | |
| | High | Bending strength | MPa | 2.0 | 1.8 | 1.7 | 2.1 | 1.5 | 1.6 | 1.9 | Unmea- |
| | temperature | Bending elastic | MPa | 39 | 26 | 24 | 35 | 30 | 35 | 40 | surable |
| | (260° C.) | modulus | | | | | | | | | |

| | | | | | | | | | |
|---|---|---|---|---|---|---|---|---|---|
| Glass-transition temperature | ° C. | 161 | 145 | 150 | 158 | 135 | 150 | 165 | 118 |
| Light transmittance | % | 91 | 90 | 90 | 91 | 90 | 91 | 89 | 89 |

| | | | | Comparative example | | | | |
|---|---|---|---|---|---|---|---|---|
| Composition recipe (parts by mass) | | | | 3 | 4 | 5 | 6 | 7 |
| (A) | Epoxy resin | TEPIC-s | A-1 | 43.5 | | 35.0 | 25.0 | |
| (B) | Epoxy resin | jER-1001 | B-1 | 18.5 | 77.2 | 15.0 | 25.0 | |
| | | EHPE-3150 | B-2 | | | | | |
| | | JER-4004P | B-4 | | | | | 61.8 |
| (C) | Acid | RIKACID MH | C-1 | 38.0 | 22.8 | 50.0 | 50.0 | 38.2 |
| | anhydride | | | | | | | |
| (D) | Curing | HISHICOLIN | D-2 | 0.3 | 0.3 | 0.3 | 0.3 | 0.3 |
| | accelerator | PX-4ET | | | | | | |

| | | | | | | |
|---|---|---|---|---|---|---|
| Condi- | Prepolymerization | Per- | Per- | Not | Not | Not |
| tion | | formed | formed | per- | per- | per- |
| | | | | formed | formed | formed |
| | (Molar number of all | 2.1 | 1.2 | 1.3 | 1.0 | 1.5 |
| | epoxy groups)/(Molar | | | | | |
| | number of acid anhydride) | | | | | |
| Evaluation | Handling property of | ∘ | ∘ | x | x | x |
| results | composition | | | | | |
| | Yellowing of molded | x | ∘ | x | x | Did not |
| | product | | | | | harden |

| | | | | | | | |
|---|---|---|---|---|---|---|---|
| Room | Bending strength | MPa | 60 | 98 | 77 | 83 | within |
| temperature | Bending elastic | MPa | 2800 | 2600 | 2600 | 2500 | 120 sec- |
| (25° C.) | modulus | | | | | | onds |
| High | Bending strength | MPa | 0.9 | Unmea- | 0.8 | Unmea- | |
| temperature | Bending elastic | MPa | 19 | surable | 11 | surable | |
| (260° C.) | modulus | | | | | | |

| | | | | | |
|---|---|---|---|---|---|
| Glass-transition temperature | ° C. | 142 | 105 | 151 | 129 |
| Light transmittance | % | 81 | 89 | 86 | 84 |

The results shown in Table 1 indicate that by performing prepolymerization, the preset invention can be pressure molded (tableted) even under a room temperature, improve its strength and elastic modulus in a high-temperature environment, and restrict an unevenness of yellowing that occurs immediately after molding. Further, it was confirmed that the present invention, due to its high glass-transition temperature, was also effective in performing secondary molding with a thermoplastic resin.

### Working Examples 7 to 11

### And Comparative Examples 8 to 17

The components (A) to (E) were added at the ratios shown in the following Table 2, followed by melting and mixing the same for 10 min in gate mixer that had been heated to 85° C. A product thus prepared was then cooled to obtain an epoxy resin composition in a state of solid or paste.

Various properties of such composition were measured as follows. The results thereof are shown in Table 2.

### Transparency of Molded Product

Molded samples obtained by performing transfer molding on the heat-curable epoxy resin were evaluated in accordance with the following standard(s).

∘: transparent molded sample
x: cloudy molded sample

### Light Transmittance

A sheet-like cured product having a thickness of 1 mm was produced at the molding temperature of 175° C. and under the molding pressure of 6.9 N/mm² for the molding period of 120 seconds. The light transmittance of such cured product at 600 nm was measured with spectrophotometer U-4100 (by Hitachi High-Technologies Corporation).

### Bending Strength and Bending Elastic Modulus Under Room Temperature

A mold made in accordance with the standard of JIS-K6911: 2006 was used to perform molding at the molding temperature of 175° C. and under the molding pressure of 6.9 N/mm² for the molding period of 120 seconds, followed by performing post curing at 180° C. for an hour. The bending strengths and elastic moduli of the post-cured test samples were measured at the room temperature (25° C.) or high temperature (260° C.).

### Continuous Moldability

MAP type packages of 50×50 mm (Cu frame plated with Ag) were continuously formed at the molding temperature of 175° C. and under the molding pressure of 6.9 N/mm² for the molding period of 120 seconds. Observations were then made about the mold releasability in a cavity section, runner breakage and an occurrence of a burr section. The number of the molded products was counted until the resin had failed to be released form the cavity section, the runner had been bended and/or the burr section had been formed.

TABLE 2

| | | | | Working example | | | | | Comparative example | | |
|---|---|---|---|---|---|---|---|---|---|---|---|
| Composition recipe (parts by mass) | | | | 7 | 8 | 9 | 10 | 11 | 8 | 9 | 10 |
| (A) | Epoxy resin | TEPIC-s | A-1 | 35.0 | 35.0 | 35.0 | 35.0 | 35.0 | 35.0 | 35.0 | 35.0 |
| (B) | Epoxy resin | jER-1001 | B-1 | 15.0 | 15.0 | 15.0 | | | 15.0 | 15.0 | 15.0 |
| | | EHPE-3150 | B-2 | | | | 15.0 | | | | |
| | | Celloxide | B-3 | | | | | 15.0 | | | |
| | | 2021P | | | | | | | | | |
| (C) | Acid | RIKACID MH | C-1 | 50.0 | 50.0 | 50.0 | 50.0 | 50.0 | 50.0 | 50.0 | 50.0 |
| | anhydride | | | | | | | | | | |
| (D) | Curing | CUREZOL | D-1 | 0.3 | 0.3 | 0.3 | 0.3 | 0.3 | 0.3 | 0.3 | 0.3 |
| | accelerator | 2E4MZ | | | | | | | | | |
| (E) | Mold release | POEM | E-1 | 1.0 | 1.0 | 2.0 | 1.0 | 1.0 | | 1.0 | |
| | agent | V-100 | | | | | | | | | |
| | | RIKEMAL | E-2 | 1.0 | 3.0 | 6.0 | 1.0 | 1.0 | | | 1.0 |
| | | PP-100 | | | | | | | | | |
| | | RIKEMAL | E-3 | 1.0 | 1.0 | 2.0 | 1.0 | 1.0 | | | |
| | | SL-800 | | | | | | | | | |
| | | TOWAX-131 | E-4 | | | | | | | | |
| | | H-22 | E-5 | | | | | | | | |
| | | LICOWAX E | E-6 | | | | | | | | |

| | | | | | | | | | | |
|---|---|---|---|---|---|---|---|---|---|---|
| Evaluation | Transparency of molded | | ∘ | ∘ | ∘ | ∘ | ∘ | ∘ | ∘ | ∘ |
| results | product | | | | | | | | | |
| | Light transmittance | % | 91 | 91 | 90 | 92 | 90 | 92 | 91 | 86 |
| | Bending strength | MPa | 78 | 70 | 66 | 69 | 63 | 80 | 77 | 74 |
| | Bending elastic modulus | MPa | 2600 | 2500 | 2300 | 2700 | 2600 | 2900 | 2700 | 2600 |
| | Continuous moldability | shot | 57 | 71 | 100 and | 60 | 49 | 1 | 2 | 5 |
| | | | | | more | | | | | |

| | | | | Comparative example | | | | | | |
|---|---|---|---|---|---|---|---|---|---|---|
| Composition recipe (parts by mass) | | | | 11 | 12 | 13 | 14 | 15 | 16 | 17 |
| (A) | Epoxy resin | TEPIC-s | A-1 | 35.0 | 35.0 | 35.0 | 35.0 | 35.0 | 35.0 | 35.0 |
| (B) | Epoxy resin | jER-1001 | B-1 | 15.0 | 15.0 | 15.0 | 15.0 | 15.0 | 15.0 | 15.0 |
| | | EHPE-3150 | B-2 | | | | | | | |
| | | Celloxide | B-3 | | | | | | | |
| | | 2021P | | | | | | | | |
| (C) | Acid | RIKACID MH | C-1 | 50.0 | 50.0 | 50.0 | 50.0 | 50.0 | 50.0 | 50.0 |
| | anhydride | | | | | | | | | |
| (D) | Curing | CUREZOL | D-1 | 0.3 | 0.3 | 0.3 | 0.3 | 0.3 | 0.3 | 0.3 |
| | accelerator | 2E4MZ | | | | | | | | |
| (E) | Mold release | POEM | E-1 | | 1.0 | | 1.0 | | | |
| | agent | V-100 | | | | | | | | |
| | | RIKEMAL | E-2 | | 1.0 | 1.0 | | | | |
| | | PP-100 | | | | | | | | |
| | | RIKEMAL | E-3 | 1.0 | | 1.0 | 1.0 | | | |
| | | SL-800 | | | | | | | | |
| | | TOWAX-131 | E-4 | | | | | 1.0 | | |
| | | H-22 | E-5 | | | | | | 1.0 | |
| | | LICOWAX E | E-6 | | | | | | | 1.0 |

| | | | | | | | | | |
|---|---|---|---|---|---|---|---|---|---|
| Evaluation | Transparency of molded | | x | | x | x | x | x | ∘ |
| results | product | | | | | | | | |
| | Light transmittance | % | 15 | 90 | 38 | 19 | 5 | 29 | 86 |
| | Bending strength | MPa | 78 | 74 | 66 | 69 | 86 | 70 | 61 |
| | Bending elastic modulus | MPa | 2700 | 2600 | 2400 | 2500 | 3000 | 2600 | 2200 |
| | Continuous moldability | shot | 15 | 4 | 26 | 22 | 28 | 7 | 1 |

The results shown in Table 2 indicate that the cured product had exhibited a high transparency, a high mold releasability and continuous moldability when combined with a particular mold release agent (s). Further, it was confirmed that the transparency and the mold releasability were difficult to be satisfied at the same time if a mold release agent is used alone.

What is claimed:

1. A heat-curable epoxy resin composition for encapsulating an optical semiconductor element, comprising:
a prepolymer obtained through a reaction of
(A) a triazine derivative epoxy resin,
(B) at least one epoxy resin selected from the group consisting of (B-1) a bisphenol A-type epoxy resin, (B-2) a bisphenol F-type epoxy resin, (B-3) a hydrogenated bisphenol A-type epoxy resin and (B-4) an alicyclic epoxy resin, and
(C) an acid anhydride curing agent, in an epoxy group equivalent to acid anhydride group equivalent ratio of 0.6 to 2.0; and
(D) a curing accelerator,
wherein said heat-curable epoxy resin composition is capable of being pressure molded under a room temperature before being thermally cured.

2. A heat-curable epoxy resin composition for encapsulating an optical semiconductor element, comprising:
(A) a triazine derivative epoxy resin;
(B) at least one epoxy resin selected from the group consisting of (B-1) a bisphenol A-type epoxy resin, (B-2) a bisphenol F-type epoxy resin, (B-3) a hydrogenated bisphenol A-type epoxy resin and (B-4) an alicyclic epoxy resin;
(C) an acid anhydride curing agent;
(D) an curing accelerator; and
(E) a mold release agent, said mold release agent being a mixture of glycerin fatty acid ester, propylene glycol fatty acid ester and higher alcohol fatty acid ester.

3. The heat-curable epoxy resin composition for encapsulating an optical semiconductor element according to claim 1, exhibiting a glass-transition temperature of not lower than 130° C. when measured through thermo-mechanical analysis (TMA).

4. An optical semiconductor device obtained by encapsulating an optical semiconductor element through transfer molding, using the heat-curable epoxy resin composition as set forth in claim 1.

5. An optical semiconductor device obtained by encapsulating an optical semiconductor element through transfer molding, using the heat-curable epoxy resin composition as set forth in claim 2.

6. An optical semiconductor device obtained by encapsulating an optical semiconductor element through transfer molding, using the heat-curable epoxy resin composition as set forth in claim 3.
